(19) United States
(12) Patent Application Publication
(10) Pub. No.: US 2008/0179356 A1
(43) Pub. Date: Jul. 31, 2008

(54) Hydration System

(75) Inventors: Clinton Wayne Edy, Crook (GB); Graham Jordison, Crook (GB); Phillip Rees, Derby (GB)

Correspondence Address: WORKMAN NYDEGGER, 60 EAST SOUTH TEMPLE, 1000 EAGLE GATE TOWER, SALT LAKE CITY, UT, 84111, US

(73) Assignee: Inoveight Limted, Durham (GB)

(21) Appl. No.: 11/937,978

(22) Filed: Nov. 9, 2007

(30) Foreign Application Priority Data
Nov. 9, 2006 (GB) GB0622297.0

(51) Int. Cl. A45F 5/00; A45F 3/00; B67D 5/64; A45F 3/16

(52) U.S. Cl. 224/148.2; 224/660; 222/175; 224/148.1

(57) ABSTRACT

An ergonomic personal hydration system, in particular for use by an athlete, comprises a bladder 20 provided with partitioning means (140, 150, 160, 170) to limit the transverse movement of fluid within the hydration system in use.

### CROSS-REFERENCE TO RELATED APPLICATIONS

The present invention claims the benefit of priority under 35 U.S.C. §119 to United Kingdom Patent Application No. GB0622297.0, filed on Nov. 9, 2006, having a title of “Hydration System,” the content of which is hereby incorporated by reference in its entirety.

### BACKGROUND OF THE INVENTION

1. The Field of the Invention

The present invention relates to personal hydration systems for the containment and ingestion of potable fluids. In particular, the invention relates to a hydration system for use by an athlete adapted for improved performance due to its ability to minimize lateral movement of the fluid during activity and its ergonomic design which reduces encumbrance to the wearer in use.

2. The Relevant Technology

Whilst some of the heat produced during exercise is stored within the body, raising body temperature; the majority of excess heat is dissipated through increased perspiration. Respiratory losses also occur during exercise, leading to an overall decrease in bodily hydration. This fluid loss is particularly prevalent during moderate or intense activity, and is further exacerbated by warm and hot conditions. Even at moderate temperatures, sweat loss can exceed 1 litre per hour for strenuous activities such as cycling or running.

It has been well documented that exercise performance is substantially impaired by dehydration with losses of as little as 2% causing diminished performance. Therefore, there is a need for ongoing rehydration during exercise and in particular for rehydration during activities of prolonged duration.

Fluids for rehydration must thus be provided in a manner that allows for adequate volumes to be available throughout the duration of activity without unduly encumbering the athlete. Furthermore, due to the competitive nature of many sporting activities it is desirable to minimize the need for interruption of the exercise during ingestion of the fluid.

Personal hydration systems are known in the art for use during exercise. These systems typically comprise reservoirs of varying sizes which are integral with, or adapted for use with conventional backpacks and where the reservoir runs vertically along the spine. The weight of the potable fluid is therefore supported by the shoulder straps of the backpack, placing a heavy load onto the upper back of the user. As the reservoir empties, the remaining fluid is contained at the bottom of the reservoir, causing a dragging effect on the upper back from the shoulder straps of the backpack. Waist-mounted packs are also known in the art, however these packs typically comprise bulky reservoirs such as those designed for use with backpacks, which have been fitted with waist straps. An inherent drawback of these waist-mounted packs is the lateral movement of fluid across the large volume reservoir in response to the motion of the athlete. This can hamper the efforts of the athlete and lead to decreased performance. Furthermore, the shifting weight of the fluid across the waist of the athlete can also cause risk of injury to the athlete.

An object of the present invention is to obviate or mitigate some or all of the aforesaid disadvantages of the prior art.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a front elevation view illustrating a hydration system according to the present invention; and

FIG. 2 is a plan view illustrating a bladder according to the present invention.

### DETAILED DESCRIPTION OF THE PREFERRED EMBODIMENTS

According to a first aspect of the present invention there is provided a personal portable hydration system adapted to be worn on the person, and comprising a bladder for the containment of a potable fluid, wherein the bladder is provided with partitioning means for limiting the transverse movement of fluid within the bladder in use and wherein the outer contours of the bladder are substantially conformable to the contours of the lumbar region of a human body.

The bladder may be configured in a variety of forms, and made from any material suitable for containment of fluids.

The portable hydration system is intended to be worn by the user such that the partitioning means are generally aligned with the spine of the wearer when the hydration system is worn on the person.

The present invention identifies the benefit of providing a personal hydration system for use by an athlete which provides dampening of the fluid motion during activity. The inclusion of the substantially vertical partitioning means in the bladder acts to compartmentalize the bladder and restricts lateral fluid movement within the bladder in response to the motion of the athlete.

Advantageously, the provision of the partitioning means further facilitates bending or folding of the hydration system at the partitioning points, allowing the hydration system to conform closely to the contours of the lumbar region of the human body.

Optionally, the partitioning means extend only partially through the bladder.

When the partitioning means are provided only partially through the bladder this advantageously means that the substantially vertical partitioning means form a series of partially discrete fluid reservoirs within the bladder. The containment of fluid in the partially discrete fluid reservoirs largely restricts lateral movement of the fluid and allows equal removal of fluid from each compartment as fluid is consumed by ingestion.

Optionally, the partitioning means is impermeable to liquids.

Alternatively, the partitioning means is semi-permeable to liquids.

Providing the partitioning means in a form that is semi-permeable to liquids allows the liquid to permeate the partitioning means in a controlled manner whether the partitioning means extend partly, or fully through the bladder. Movement of the fluid between the reservoirs is dampened by the movement of fluid through the semi-permeable partitioning means, allowing the fluid to be largely contained in the semi-partitioned reservoirs.

Preferably, the bladder comprises four substantially vertical partitioning means forming five partially discrete fluid reservoirs.

Preferably, the outer contours of the bladder are substantially shaped to contour to the lumbar region of a human body.

The ergonomic shape of the bladder ensures that the hydration system provides support to the lumbar region of the back in use.

Preferably, the bladder is shaped such that the bladder is widest in a vertical direction at the centre of the bladder.

Advantageously, as the bladder is widest in a vertical direction at the centre of the bladder, this corresponds with the small of the back of the human body. This allows the bladder to fit snugly against the back of the athlete in use and further provides support to the base of the lumbar region of the spine.

Preferably, the bladder is approximately 125-160 mm wide in a vertical direction at its widest aspect at the centre of the bladder.

Preferably, the bladder tapers from the centre of the bladder towards the sides of the bladder.

As the bladder tapers from its widest aspect at the centre of the bladder towards the sides of the bladder, the bladder is narrower towards its sides, approaching the hips of the athlete when worn. This conveniently minimizes impedance to the athlete when in use.

Preferably, the bladder is 50-70 mm wide at its narrowest aspect near the sides of the bladder.

Preferably, the partitioning means are provided in an unequal distribution along the length of the bladder.

Providing the partitioning means in an unequal distribution along the length of the bladder allows partially discrete fluid reservoirs of differing sizes to be created. Thus, the largest partially discrete fluid reservoir can be provided at the centre of the pack, where the bladder is at its widest. This allows for the heaviest weight of fluid to be contained at the centre of the back, reducing the risk of injury to the athlete and allowing the bladder, when filled with fluid to provide support to the lumbar region of the spine.

This distribution also facilitates folding of the hydration system at the appropriate points such that a close contour to the lumbar region of the human body can be obtained.

Preferably, the partitioning means are provided at approximately 100-110 mm, 210-220 mm, 380-390 mm and 485-495 mm along the length of the bladder.

Preferably, the bladder is held in use at the back of the athlete.

Advantageously, providing the bladder at the back of the athlete allows the bladder to provide support to the lumbar region of the spine.

Preferably, the hydration system comprises an outer pack in which the bladder is contained.

Preferably, the bladder is releasably contained in the outer pack.

Optionally, the bladder is permanently contained in the outer pack.

Preferably, the bladder is fixed into position in the outer pack.

Fixing the bladder into position when contained within the outer pack is important as it ensures that when the volume of the bladder decreases due to the removal of fluid therefrom, the bladder is still held against the inner walls of the outer pack, preventing the bladder from moving about the outer pack.

Preferably, the outer pack is formed of an inelastic material.

Providing the outer pack in an inelastic material, ensures that the pack is held against the bladder and prevents relative movement of the outer pack and the bladder in response to the motion of the athlete.

Preferably, the hydration system comprises attachment means for fixing the hydration system around the waist of a user.

Preferably, the attachment means is associated with the outer pack.

Alternatively, the attachment means is associated with the bladder.

Preferably the attachment means comprises a waist belt.

Preferably the hydration system comprises means for facilitating ingestion of fluid from the bladder.

More preferably, the hydration system comprises an ingestion tube, which transports fluid from the bladder to the mouth of the athlete.

Preferably, the ingestion tube comprises a valve at the user end of the tube.

Optionally, the ingestion tube comprises a bite valve.

Providing a bite valve at the user end of the ingestion tube allows the athlete to control the ingestion of water in use.

Preferably, the bladder comprises an inlet port through which fluid can be introduced into the bladder.

Preferably, the bladder and the ingestion tube are formed of an anti-microbial material or are provided with an anti-microbial coating.

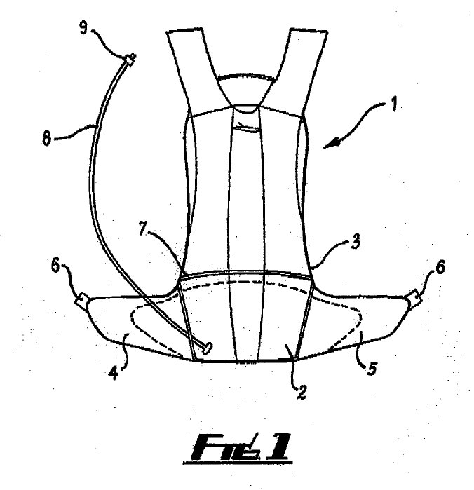

Referring firstly to FIG. 1, the drawing shows a hydration system generally depicted at 1. The hydration system comprises a bladder 2 contained within an outer pack 3 that is formed of an inelastic material such as polyester or woven nylon. The outer pack 3, which in the depicted embodiment is a backpack, is fitted with waist straps 4,5, that circumvent the waist of an athlete in use. The waist straps 4,5 comprise a buckle 6, which allow the waist straps to be adjusted to fit the athlete and then securely fastened around the waist. The waist straps are padded to increase comfort to the athlete when worn. In use, the outer pack 3, sits against the lumbar region of the spine of the athlete and is fastened to the front of the athlete.

A flap or opening 7, is provided at the lower section of the outer pack 3 through which the bladder can be removably inserted into the outer pack. Conveniently, this allows for the bladder to be changed or refilled without the need to unpack the other contents of the outer pack. An ingestion tube 8, formed from polyethylene or similar anti-microbial plastic material and which is in fluid communication with the inner volume of the bladder 2, runs from an outlet port (not shown) in the bladder, and through a suitable opening in the outer pack 3 towards the mouth of a athlete to allow the fluid to be ingested. The ingestion tube 8 is of sufficient length to reach the mouth of the athlete and varying sizes of ingestion tubes can be envisaged. A bite-valve 9 at the user end of the ingestion tube 9 allows the athlete to control the ingestion of fluid from the bladder 2.

While in the depicted embodiment a backpack is shown, it will be understood that the outer pack could be provided as a waist pack only.

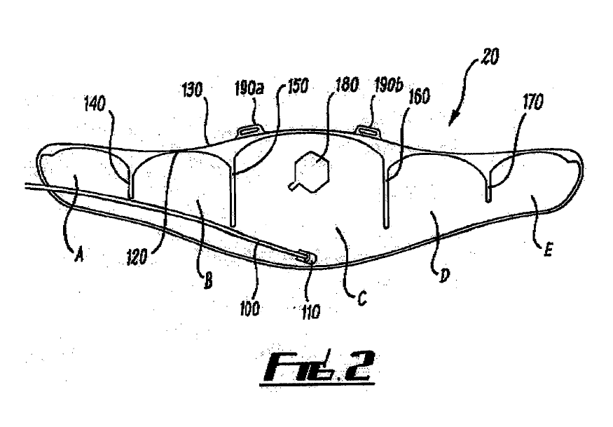

Turning now to FIG. 2, the drawing shows a bladder generally depicted at 20. The walls of the bladder are formed from a single layer of a suitable waterproof material such as polyvinylchloride (PVC) or polyurethane, the single layer defining an inner surface 120 and an outer surface 130. The waterproof material is anti-microbial, or comprises an anti-microbial coating to block the growth of bacterial within the hydration system. The bladder is approximately 600 mm in length, and approximately 142 mm in width at its widest aspect at the centre of the bladder.

The opposing inner surfaces of the layer of waterproof material are joined together to form a seam at approximately 106 mm, 216 mm, 384 mm and 490 mm along the length of the bladder 20. These seams, indicated at 140, 150, 160 and 170 run downwards in a vertical direction across approximately two-thirds of the width of the bladder 20. The seams 140, 150, 160, 170 may be formed by any suitable means such as ultrasonic, dielectric RF welding, adhesive, or thermal impulse sealing, to form partial vertical partitions through the inner volume of the bladder 20. Semi-permeable partitions can also be employed, for example by the stitching together of the opposing inner surfaces, allowing fluid to permeate in a controlled manner through the seams. The bladder is thus segmented into five semi-discrete reservoirs, indicated at A, B, C, D and E.

The bladder 20 comprises an inlet port 180, through which the bladder can be filled with any suitable rehydrating fluid such as water, juice or isotonic formulations. The inlet port 180 comprises a threaded neck, with a complementary cap (not shown) which creates a watertight seal when closed.

The ingestion tube 80 comprises a polyurethane tube which extends from an outlet port 100 to the mouth of the athlete. The ingestion tube 80 comprises a bite valve (not shown) at the ingestion end of the tube.

The bladder 20 comprises loops 190a, 190b by which the bladder can be affixed into the outer pack, by threading through a tie comprising fastening means such as hook and loop fasteners (for example VELCRO™), although it will be understood that any suitable means could be employed for this purpose.

It will be evident that various modifications and improvements could be made to the above-described sole within the scope of the invention. For example, the ingestion tube may comprise a suitable clip for releasably securing the ingestion tube to clothing of the athlete in use. Furthermore, it is indicated that the outer pack is formed of an inelastic material. However, it is envisaged that suitable elastic materials may also be employed. An alternative wherein the partitioning means could be formed by internal walls instead of seams is also envisaged. Furthermore, the bladder may also comprise upper and lower walls which provide the bladder with greater depth, increasing the volume of fluid that can be held within. As another alternative, the bladder may comprise a wide top flap opening with a slidable cap to allow rapid filling of the bladder.

Further modifications may be made without departing from the scope of the invention herein intended. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A personal portable hydration system adapted to be worn on the person, and comprising a bladder for the containment of a potable fluid, wherein the bladder is provided with at least one partitioning means for limiting the transverse movement of fluid within the bladder in use and the outer contours of the bladder are substantially conformable to the contours of the lumbar region of a human body.

2. A personal portable hydration system as in claim 1 wherein the partitioning means extends only partially through the bladder.

3. A personal portable hydration system as in claim 1 wherein the partitioning means is impermeable to liquids.

4. A personal portable hydration system as in claim 1 wherein the partitioning means is semi-permeable to liquids.

5. A personal portable hydration system as in claim 1 wherein the bladder comprises four substantially vertical partitioning means forming five at least partially discrete fluid reservoirs.

6. A personal portable hydration system as claim 1 wherein the bladder is shaped such that the bladder is widest in a vertical direction at the centre of the bladder.

7. A personal portable hydration system as in claim 1 wherein the bladder is approximately 125-160 mm wide in a vertical direction at its widest aspect at the centre of the bladder.

8. A personal portable hydration system as in claim 1 wherein the bladder tapers from the centre of the bladder towards the sides of the bladder.

9. A personal portable hydration system as in claim 1 wherein the bladder is 50-70 mm wide at its narrowest aspect near the sides of the bladder.

10. A personal portable hydration system as in claim 1 wherein the partitioning means are provided in an unequal distribution along the length of the bladder.

11. A personal portable hydration system as in claim 1 wherein the partitioning means are provided at approximately 100-110 mm, 210-220 mm, 380-390 mm and 485-495 mm along the length of the bladder.

12. A personal portable hydration system as in claim 1 wherein the hydration system comprises an outer pack in which the bladder is contained.

13. A personal portable hydration system as in claim 12 wherein the bladder is releasably contained in the outer pack.

14. A personal portable hydration system as in claim 12 wherein the bladder is permanently contained in the outer pack.

15. A personal portable hydration system as in claim 12 wherein the bladder is fixed into position in the outer pack.

16. A personal portable hydration system as in claim 12 wherein the outer pack is formed of an inelastic material.

17. A personal portable hydration system as in claim 1 wherein the hydration system comprises attachment means for fixing the hydration system around the waist of a user.

18. A personal portable hydration system as in claim 17 wherein the attachment means is associated with an outer pack.

19. A personal portable hydration system as in claim 17 wherein the attachment means is associated with the bladder.

20. A personal portable hydration system as in claim 17 wherein the bladder is held in use at the back of the athlete.

21. A personal portable hydration system as in claim 1 wherein the hydration system comprises means for facilitating ingestion of fluid from the bladder.

22. A personal portable hydration system as in claim 1 wherein the hydration system comprises an ingestion tube, which transports fluid from the bladder to the mouth of the athlete.

23. A personal portable hydration system as in claim 1 wherein the bladder comprises an inlet port through which fluid can be introduced into the bladder.
